(19) United States
(12) Patent Application Publication
(10) Pub. No.: US 2010/0020930 A1
(43) Pub. Date: Jan. 28, 2010

(54) RADIOGRAPHIC APPARATUS AND RADIATION DETECTION SIGNAL PROCESSING METHOD

(76) Inventor: Shoichi Okamura, Kyoto (JP)

Correspondence Address: Cheng Law Group, PLLC, 1100 17th Street, N.W., Suite 503, Washington, DC, 20036, US

(21) Appl. No.: 12/518,639

(22) PCT Filed: Dec. 12, 2006
(86) PCT No.: PCT/JP2006/324759

§ 371 Date: Jun. 10, 2009

(51) Int. Cl. G03B 42/02

(52) U.S. Cl. 378/62

(57) ABSTRACT

With a radiographic apparatus according to this invention, a storage time for storing X-ray detection signals is a fixed predetermined time without regard to an irradiation time, and imaging is performed with only one type of storage time. Even with only one type of storage time, it is possible to read the X-ray detection signals stored for the fixed predetermined time for every one image, thereby obtaining stored frame data for multiple images, and to obtain X-ray images based on the multiple stored frame data associated with irradiation. Thus, imaging and signal processing can be performed with one type of storage time.

### TECHNICAL FIELD

This invention relates to a radiographic apparatus for medical or industrial use and a radiation detection signal processing method, for obtaining radiographic images based on radiation detection signals. More particularly, the invention relates to a technique for storing and reading the radiation detection signals.

### BACKGROUND ART

Conventionally, an imaging apparatus for detecting X rays to obtain X-ray images, which is one example of radio-graphic apparatus, used an image intensifier (I.I) as an X-ray detecting device. Recently, a flat panel X-ray detector (hereinafter abbreviated to “FPD”) has been used.

The FPD has a sensitive film laminated on a substrate, detects radiation incident on the sensitive film, converts the detected radiation into electric charges, and stores the electric charges in capacitors arranged in a two-dimensional array. The electric charges stored are read by turning on switching elements, and are transmitted as radiation detection signals to an image processor. The image processor obtains an image having pixels based on the radiation detection signals.

Such FPD is lighter in weight than the conventionally used image intensifier, and prevents occurrence of complicated detected distortions. Thus, the FPD is advantageous in terms of apparatus construction and image processing.

In the imaging device using the FPD, as shown in FIG. 6, an X-ray irradiation time of an X-ray tube is controlled by a photo-timer, and a storage time and a reading time are each controlled on the basis of the irradiation time controlled by the photo-timer. Here, the “storage time” refers to a time for radiation to be stored in the FPD and the “reading time” refers to a time for radiation to be read from the FPD. For example, the irradiation time becomes longer for imaging a larger subject. Where the irradiation time becomes longer, the storage time also becomes longer with the irradiation time, as shown in FIG. 6. As a result, a suitable dose of radiation strikes on the detector, typically an FPD, regardless of the size of the subject, to obtain an X-ray image.

In view of the extension of the irradiation time noted above, it seems necessary to provide only one type of sufficiently long storage time. Actually, however, such a measure will not help. That is, there exists a phenomenon in which a longer storage time with respect to a reading time leads to increased defective pixels. Thus, it is not desirable to extend the storage time. Desirably, collection should be completed in a short storage time if possible. On the other hand, there exists a rare case of imaging a large subject that requires an irradiation lasting as long as several seconds, and thus a sufficiently long storage time is also necessary. Then, considering the above, several types of storage time with different durations are prepared and the shortest storage time is selected in which the X-ray irradiation is completely included.

### DISCLOSURE OF THE INVENTION

### Problem to be Solved by the Invention

However, variations in the storage time need correction data (an offset, a gain, a defect map) corresponding to the storage times. Which storage time should be used for imaging can be determined only after the imaging is completed. Therefore, correction data (calibration data) must be prepared in advance that copes with all conceivable storage times. This calibration (obtaining of calibration data) is usually performed at start-up of an apparatus. As the types of storage time held by the apparatus increases, a required time for the calibration is also extended. With a system having two FPDs used for imaging standing and lying postures (a standing posture and a lying posture), a further extension of the required time (approximately 20 minutes) occurs due to the two FPDs, which leads to a problem. Thus, there is a demand for such a method that is usable for a large subject, minimizes defective pixels, and shortens the required time for calibration.

This invention has been made in view of the state of the art noted above, and its object is to provide a radiographic apparatus and a radiation detection signal processing method capable of imaging or signal processing with few types of storage time.

This invention provides the following construction in order to achieve the above object.

The radiographic apparatus of this invention is a radiographic apparatus for obtaining radiographic images based on radiation detection signals, comprising a radiation emitting device for emitting radiation toward a subject; and a radiation detecting device for detecting radiation transmitted through the subject; the apparatus further comprising an imaging control device for controlling storage of the radiation detection signals in the radiation detecting device to be performed for a fixed predetermined time, without regard to an irradiation time of the radiation emitting device, in order to fetch the radiation detection signals from the radiation detecting device, and controlling imaging by reading, for every one image, the radiation detection signals stored for the fixed predetermined time, thereby obtaining stored frame data for multiple images; and a radiographic image obtaining device for obtaining the radiographic images based on the multiple stored frame data associated with irradiation.

With the radiographic apparatus of this invention, in order to fetch the radiation detection signals from the radiation detecting device, the imaging control device controls storage of the radiation detection signals in the radiation detecting device to be performed for the fixed predetermined time, without regard to the irradiation time of the radiation emitting device. The imaging control device controls imaging also by reading the radiation detection signals stored for the above fixed predetermined time for every one image to obtain stored frame data for multiple images. On the other hand, the radiographic image obtaining device obtains radiographic images based on the above multiple stored frame data associated with irradiation. Thus, the storage time for storing the radiation detection signals is a fixed predetermined time without regard to the irradiation time, and the imaging is performed with only one type of storage time. Even with only one type of storage time, it is possible to read the radiation detection signals stored for the fixed predetermined time for every one image, thereby obtaining the stored frame data for multiple images, and to obtain the radiographic images based on the multiple stored frame data associated with irradiation. Therefore, imaging can be performed with one type of storage time.

The radiation detection signal processing method of this invention is a radiation detection signal processing method for performing signal processing by fetching radiation detection signals detected by irradiating a subject and obtaining radiographic images based on the fetched radiation detection signals, wherein, in order to fetch the radiation detection signals, the radiation detection signals are stored in a radiation detecting device for a fixed predetermined time without regard to an irradiation time of radiation and the radiation detection signals stored for the fixed predetermined time are read for every one image, thereby obtaining stored frame data for multiple images, and wherein the radiographic images are obtained based on the multiple stored frame data associated with irradiation.

With the radiation detection signal processing method of this invention, in order to fetch the radiation detection signals, the radiation detecting device stores the radiation detection signals for the fixed predetermined time without regard to the irradiation time of radiation. Subsequently, the radiation detection signals stored for the above fixed predetermined time are read for every one image, and stored frame data for multiple images is obtained. On the other hand, the radiographic images are obtained based on the above multiple stored frame data associated with irradiation. Thus, the storage time for storing the radiation detection signals is a fixed predetermined time without regard to the irradiation time, and imaging is performed with only one type of storage time. Even with only one type of storage time, it is possible to read the radiation detection signals stored for the fixed predetermined time for every one image, thereby obtaining the stored frame data for multiple images, and to obtain radiographic images based on the multiple stored frame data associated with irradiation. Therefore, signal processing can be performed with one type of storage time.

In the radiographic apparatus and the radiation signal processing method of this invention, it is preferred that a storage time, which is the fixed predetermined time for storing the radiation detection signals, is equal to a reading time for one image for reading the radiation detection signals from the radiation detecting device. As noted hereinbefore, a phenomenon is known in which a longer storage time with respect to a reading time leads to increased defective pixels. Thus, setting the storage time equal to the reading time can minimize defective pixels.

In the radiographic apparatus and the radiation signal processing method of this invention, one example of the multiple stored frame data associated with irradiation mentioned above includes data from a stored frame when the irradiation is started to a frame immediately following a stored frame when the irradiation is ended. The multiple stored frame data associated with irradiation may be obtained based on added data, which is obtained by adding data from the stored frame when the irradiation is started to the frame immediately following the stored frame when the irradiation is ended. For example, averaging (arithmetic mean) obtained by division of the added data by the number of frames may be used as the multiple stored frame data associated with irradiation. The added data itself may be also used as the multiple stored frame data associated with irradiation.

### Effect of the Invention

With the radiographic apparatus and the radiation detection signal processing method according to this invention, a storage time for storing radiation detection signals is a fixed predetermined time without regard to an irradiation time, and imaging is performed with only one type of storage time. Even with only one type of storage time, it is possible to read the radiation detection signals stored for the fixed predetermined time for every one image, thereby obtaining stored frame data for multiple images, and to obtain radiation images based on the multiple stored frame data associated with irradiation. Thus, imaging or signal processing can be performed with one type of storage time.

### BRIEF DESCRIPTION OF THE DRAWINGS

FIG. 1 is a block diagram of an X-ray fluoroscopic apparatus according to an embodiment;

FIG. 2 is an equivalent circuit, seen in side view, of a flat panel X-ray detector used in the X-ray fluoroscopic apparatus;

FIG. 3 is an equivalent circuit, seen in plan view, of the flat panel X-ray detector;

FIG. 4 is a timing chart of imaging control and X-ray image obtainment;

FIG. 5 is a flow chart showing a series of signal processing by an image processor and a controller; and

FIG. 6 is a timing chart of conventional imaging control and X-ray image obtainment.

### DESCRIPTION OF REFERENCES

2 . . . X-ray tube

3 . . . flat panel X-ray detector (FPD)

9 . . . image processor

10 . . . controller

M . . . subject

### EMBODIMENT

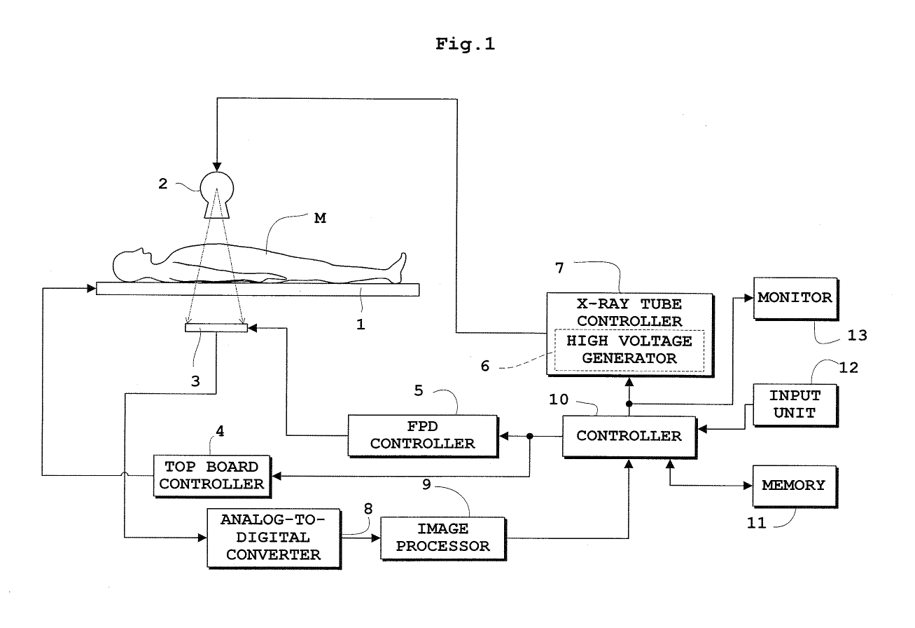

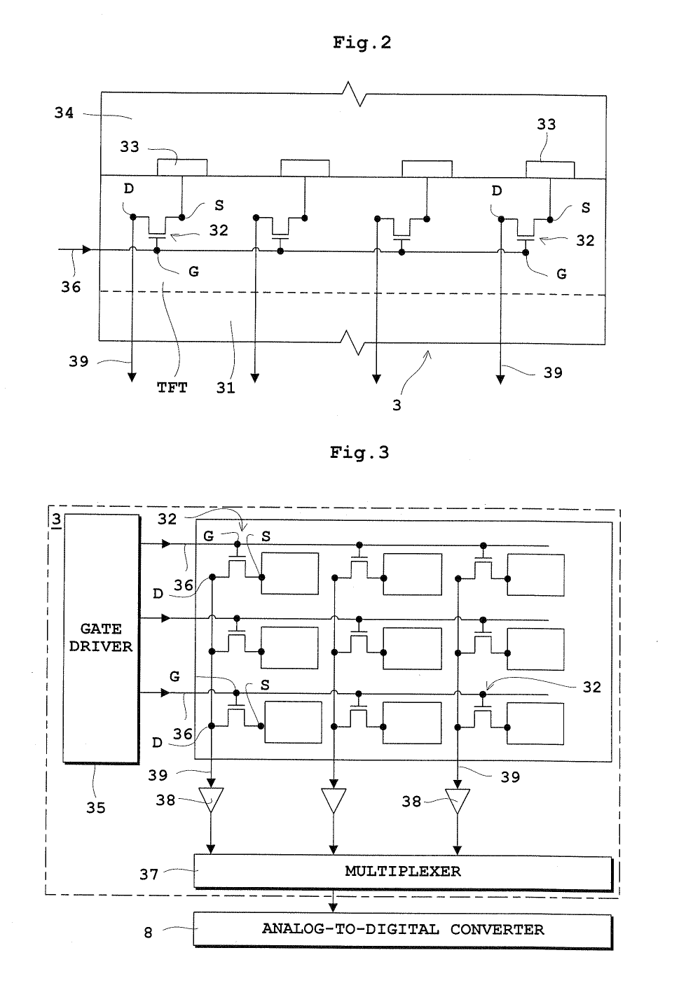

An embodiment of this invention will be described hereinafter with reference to the drawings. FIG. 1 is a block diagram of an X-ray fluoroscopic apparatus according to an embodiment. FIG. 2 is an equivalent circuit, seen in side view, of a flat panel X-ray detector used in the X-ray fluoroscopic apparatus. FIG. 3 is an equivalent circuit, seen in plan view, of the flat panel X-ray detector. This embodiment will be described, taking a flat panel X-ray detector (hereinafter called “FPD” as appropriate) as an example of the radiation detecting device, and an X-ray fluoroscopic apparatus as an example of the radiographic apparatus.

As shown in FIG. 1, the X-ray fluoroscopic apparatus according to the embodiment includes a top board 1 for supporting a subject M, an X-ray tube 2 for irradiating the subject M with X rays, and an FPD 3 for detecting X rays transmitted through the subject M. The X-ray tube 2 corresponds to the radiation emitting device in this invention. The FPD 3 corresponds to the radiation detecting device in this invention.

The X-ray fluoroscopic apparatus further includes a top board controller 4 for controlling vertical and horizontal movements of the top board 1, an FPD controller 5 for controlling scanning movement of the FPD 3, an X-ray tube controller 7 having a high voltage generator 6 for generating a tube voltage and tube current for the X-ray tube 2, an analog-to-digital converter 8 for digitizing X-ray detection signals as charge signals from the FPD 3 and fetching the X-ray detection signals, an image processor 9 for performing various processes based on the X-ray detection signals outputted from the analog-to-digital converter 8, a controller 10 for performing an overall control of these components, a memory 11 for storing processed images, etc., an input unit 12 for an operator to input various settings, and a monitor 13 for displaying the processed images, and so on.

The top board controller 4 controls the top board 1 so as to move horizontally to place the subject M in an imaging position, vertically move, rotate, and horizontally move to set the subject M to a desired position, perform imaging while moving horizontally, and horizontally move away from the imaging position after the imaging. The FPD controller 5 controls scanning movement by moving the FPD 3 horizontally or rotationally moving the FPD 3 about a body axis of the subject M. The high voltage generator 6 generates a tube voltage and tube current for emitting X-rays to apply the X-rays to the X-ray tube 2. The X-ray tube controller 7 controls scanning movement by moving the X-ray tube 2 horizontally or rotationally moving the X-ray tube 2 about the body axis of the subject M, and controls setting of an irradiation filed of a collimator (not shown) disposed on the side of the X-ray tube 2. In time of scanning movement, the X-ray tube 2 and FPD 3 move while facing each other, so that the FPD 3 can detect X rays emitted from the X-ray tube 2.

The controller 10 has a central processing unit (CPU), etc. The memory 11 has a storage medium, typically a ROM (Read-Only Memory) or RAM (Random Access Memory). The input unit 12 has a pointing device, typically a mouse, keyboard, joystick, trackball, or touch panel. The X-ray fluoroscopic apparatus performs imaging of the subject M, with the FPD 3 detecting X rays transmitted through the subject M, and the image processor 9 performing image processing based on the detected X rays.

The controller 10 in this embodiment has a function that, in order to fetch X-ray detection signals from the FPD 3, controls storage of the X-ray detection signals in the FPD 3 to be carried out for a fixed predetermined time without regard to an irradiation time of the X-ray tube 2, and a function that controls imaging by reading the X-ray detection signals stored for the fixed predetermined time (storage time) for every one image and then obtaining stored frame data for multiple images. Therefore, the controller 10 corresponds to the imaging control device in this invention.

In this embodiment, the image processor 9 has a function to obtain X-ray images based on the above multiple stored frame data associated with the irradiation. Thus, the image processor 9 corresponds to the radiographic image obtaining device in this invention.

As shown in FIG. 2, the FPD 3 includes a glass substrate 31, and thin film transistors TFT formed on the glass substrate 31. As shown in FIGS. 2 and 3, the thin film transistors TFT include numerous switching elements 32 arranged in a two-dimensional matrix of rows and columns (e.g. 1,024×1,024). The switching elements 32 are formed separately from one another for the respective carrier collection electrodes 33. Thus, the FPD 3 is also a two-dimensional array radiation detector.

As shown in FIG. 2, an X-ray sensitive semiconductor 34 is laminated on the carrier collection electrodes 33. As shown in FIGS. 2 and 3, the carrier collection electrodes 33 are connected to the sources S of the switching elements 32. A plurality of gate bus lines 36 are connected from a gate driver 35, and are each connected to gates G of the switching elements 32. On the other hand, as shown in FIG. 3, a plurality of data bus lines 39 are connected via amplifiers 38 to a multiplexer 37 for collecting charge signals and outputting them as one. As shown in FIGS. 2 and 3, the data bus lines 39 are each connected to drains D of the switching elements 32.

The gates of the switching elements 32 are turned on by applying (or reducing to 0V) the voltage of the gate bus lines 36 in a state where a bias voltage is applied to a common electrode not shown. The carrier collection electrodes 33 read the charge signals (carriers) converted from X rays incident on the detection surface via the X-ray sensitive semiconductor 34, into the data bus lines 39 via the sources S and drains D of the switching elements 32. The charge signals are provisionally stored in capacitors (not shown) until the switching elements are turned on. The amplifiers 38 amplify the charge signals read into the data bus lines 39, and the multiplexer 37 collects the charge signals, and outputs them as one charge signal. The analog-to-digital converter 8 digitizes the outputted charge signal, and outputs it as an X-ray detection signal.

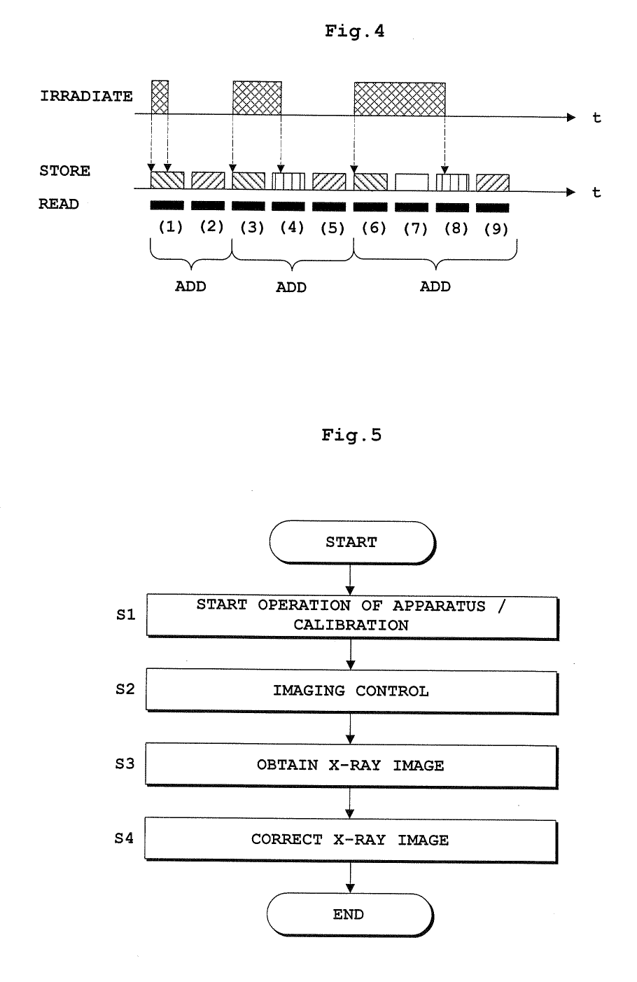

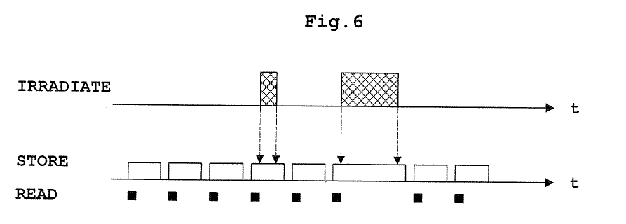

Next, a series of signal processing by the image processor 9 and the controller 10 according to this embodiment will be described with reference to a timing chart shown in FIG. 4 and a flow chart shown in FIG. 5. FIG. 4 is a timing chart of imaging control and X-ray image obtainment. FIG. 5 is a flow chart showing a series of signal processing by the image processor and the controller.

(Step S1) Start Apparatus/Calibration

The apparatus is started. Calibration (obtaining of calibration data) is performed at the time of starting the apparatus. Specifically, correction data (calibration data) is obtained that corresponds to only one type of storage time (e.g. 133 ms). The calibration data includes, for example, an offset, gain, defective map, and so on. Where the storage time is only one type, i.e. 133 ms, and calibration data is an offset, gain, or defective map, calibration is completed in around one minute.

(Step S2) Imaging Control

The timing of starting irradiation is determined by operation of the input unit 12 (see FIG. 1), such as a hand switch. Specifically, when the hand switch is pressed down, irradiation pulses are outputted synchronously with a frame immediately following the press-down as shown in FIG. 4, to emit X rays from the X-ray tube 2 (see FIG. 1). When a predetermined condition is fulfilled (e.g. when an accumulated dose reaches a predetermined amount), the irradiation pulses are disconnected by a photo-timer, thereby ending irradiation with X rays.

The controller 10 (see FIG. 1) performs control to repeat the storage time and reading time fixedly without regard to the irradiation time. The controller also sets the storage time equal to the reading time as shown in FIG. 4, in order to minimize defective pixels. Where the storage time is 133 ms, the reading time is also set to 133 ms, which are to be repeated for every frame.

In FIG. 4, store frames at which irradiation is started are depicted with backward slashes, store frames at which irradiation is ended with vertical lines, and frames immediately following the irradiation-ending store frames with forward slashes.

For instance, when irradiation is started at a first frame (see (1) in FIG. 4) and is ended at the same first frame, the store frame at which irradiation is started is the first frame and the store frame at which the irradiation is ended is also the first frame. The store frame immediately following the store frame at which the irradiation is ended is a second frame (see (2) in FIG. 4). Consequently, the first frame is depicted with backward slashes, and the second frame with upward slashes. If the first frame were depicted with vertical lines, the vertical lines would overlap the backward slashes. Thus, depiction is not made with vertical lines here.

When, for instance, irradiation is started at a third frame (see (3) in FIG. 4) and is ended at a fourth frame (see (4) in FIG. 4), the store frame at which irradiation is started is the third frame and the store frame at which the irradiation is ended is the fourth frame. The store frame immediately following the store frame at which the irradiation is ended is a fifth frame (see (5) in FIG. 4). Consequently, the third frame is depicted with backward slashes, the fourth frame with vertical lines, and the fifth frame with forward slashes.

Furthermore, when, for instance, irradiation is started at a sixth frame (see (6) in FIG. 4) and is ended at an eighth frame (see (8) in FIG. 4), the store frame at which the irradiation is started is the sixth frame and the store frame at which the irradiation is ended is the eighth frame. The store frame immediately following the store frame at which the irradiation is ended is a ninth frame (see (9) in FIG. 4). Consequently, the sixth frame is depicted with backward slashes, the eighth frame with vertical lines, and the ninth frame with forward slashes.

The controller 10 (see FIG. 1) reads for every one image X-ray detection signals stored for the fixed predetermined time (storage time) as mentioned above, and obtains stored frame data for multiple images.

(Step S3) Obtain X-ray Image

The image processor 9 (see FIG. 1) obtains X-ray images based on the multiple stored frame data associated with irradiation.

When, for instance, irradiation is started at the first frame (see (1) in FIG. 4) and is ended at the same first frame, data is added from the first frame at which the irradiation is started to the second frame (see (2) in FIG. 4) immediately following the store frame at which the irradiation is ended.

When, for instance, irradiation is started at the third frame (see (3) in FIG. 4) and is ended at the fourth frame (see (4) in FIG. 4), data is added from the third frame at which the irradiation is started to the fifth frame (see (5) in FIG. 4) immediately following the store frame at which the irradiation is ended.

Furthermore, when, for instance, irradiation is started at the sixth frame (see (6) in FIG. 4) and is ended at the eighth frame (see (8) in FIG. 4), data is added from the sixth frame at which the irradiation is started to the ninth frame (see (9) in FIG. 4) immediately following the store frame at which the irradiation is ended.

The image processor 9 (see FIG. 1) obtains added data obtained by adding as mentioned above, as a plurality of stored frame data associated with irradiation. The stored frame data are processed into an X-ray image.

(Step S4) Correct X-ray Image

The X-ray images obtained in Step S4 are corrected based on the calibration data (an offset, gain, defective map) obtained in Step S1. Logarithmic transformation, for example, may also be performed. The X-ray images corrected as mentioned above are outputted to be displayed on the monitor 13 (see FIG. 1) or to be printed out with a printer (not shown).

According to the embodiment configured as described above, in order to fetch X-ray detection signals from the flat panel X-ray detector (FPD) 3, the controller 10 carries out controls to store the X-ray detection signals in the FPD 3 for the fixed predetermined time (e.g., 133 ms), without regard to the irradiation time of the X-ray tube 2. Imaging is then controlled by reading the X-ray detection signals stored for the above fixed predetermined time for every one image, and obtaining the stored frame data for multiple images. On the other hand, the image processor 9 obtains X-ray images based on the above-mentioned plurality of stored frame data associated with irradiation. Thus, the storage time for storing the X-ray detection signals is a fixed predetermined time without regard to an irradiation time, and imaging is performed with only one type of storage time. Even with only one type of storage time, it is possible to read, for every one image, the X-ray detection signals stored for the fixed predetermined time, thereby obtaining the stored frame data for multiple images, and to obtain radiographic images based on the multiple stored frame data associated with irradiation. Consequently, imaging and signal processing can be performed with one type of storage time. In addition, one type of storage time produces an effect of shortening the time required for calibration.

As in this embodiment, the storage time is a fixed predetermined time for storing X-ray detection signals, and is preferably equal to the reading time for one image for reading the X-ray detection signals from the FPD3. As noted hereinbefore, a phenomenon is known in which a longer storage time with respect to a reading time leads to increased defective pixels. Thus, setting the storage time equal to the reading time can minimize defective pixels.

In this embodiment, the multiple stored frame data associated with irradiation is from a stored frame at which the irradiation is started to a frame immediately following a stored frame at which the irradiation is ended. Moreover, the multiple stored frame data associated with irradiation is obtained based on added data, which is obtained by adding data from a stored frame at which the irradiation is started to a frame immediately following a stored frame at which the irradiation is ended. In this embodiment, the added data itself is used as the multiple stored frame data associated with irradiation. In addition, averaging (arithmetic mean) obtained by division of the added data by the number of frames may be used as the multiple stored frame data associated with irradiation.

This invention is not limited to the foregoing embodiment, but may be modified as follows.

(1) In the above embodiment, the X-ray fluoroscopic apparatus as shown in FIG. 1 has been described by way of example. This invention may be applied also to an X-ray fluoroscopic apparatus mounted on a C-shaped arm, for example. This invention may be applied also to an X-ray CT apparatus. Moreover, this invention is especially useful when actually producing radiographs (rather than fluoroscopy) as with an X-ray apparatus.

(2) In the above embodiment, the flat panel X-ray detector (FPD) 3 has been described by way of example. This invention is applicable to any X-ray detecting device used in ordinary circumstances.

(3) In the above embodiment, the X-ray detector for detecting X rays has been described by way of example. This invention is not limited to a particular type of radiation detector, but may be applied, for example, to a gamma-ray detector for detecting gamma rays emitted from a subject dosed with radioisotope (RI), such as in an ECT (Emission Computed Tomography) apparatus. Similarly, this invention is not limited to a particular apparatus, but may be applied to any apparatus that detects radiation for imaging, as exemplified by the ECT apparatus mentioned above.

(4) In the above embodiment, the FPD 3 is a direct conversion type detector with a radiation (X-ray in the embodiment) sensitive semiconductor for converting incident radiation directly into charge signals. Instead of the radiation sensitive type, the detector may be the indirect conversion type with a light sensitive semiconductor and a scintillator, in which incident radiation is converted into light by the scintillator, and the light is converted into charge signals by the light sensitive semiconductor.

(5) In the above embodiment, the storage time has been equal to the reading time. Where suppressing defective pixels is not considered, it is not absolutely necessary for the storage time to be equal to the reading time.

1. A radiographic apparatus for obtaining radiographic images based on radiation detection signals, comprising:
a radiation emitting device for emitting radiation toward a subject; and
a radiation detecting device for detecting radiation transmitted through the subject;
the apparatus further comprising:
an imaging control device for controlling storage of the radiation detection signals in the radiation detecting device to be performed for a fixed predetermined time, without regard to an irradiation time of the radiation emitting device, in order to fetch the radiation detection signals from the radiation detecting device, and controlling imaging by reading, for every one image, the radiation detection signals stored for the fixed predetermined time, thereby obtaining stored frame data for multiple images; and
a radiographic image obtaining device for obtaining the radiographic images based on the multiple stored frame data associated with irradiation.

2. The radiographic apparatus according to claim 1, wherein a storage time, which is the fixed predetermined time for storing the radiation detection signals, is equal to a reading time for one image for reading the radiation detection signals from the radiation detecting device.

3. The radiographic apparatus according to claim 1, wherein the multiple stored frame data associated with irradiation is from a stored frame when the irradiation is started to a frame immediately following a stored frame when the irradiation is ended.

4. The radiographic apparatus according to claim 3, wherein the multiple stored frame data associated with irradiation is obtained based on added data, which is obtained by adding data from the stored frame when the irradiation is started to the frame immediately following the stored frame when the irradiation is ended.

5. A radiation detection signal processing method for performing signal processing by fetching radiation detection signals detected by irradiating a subject and obtaining radiographic images based on the fetched radiation detection signals, wherein, in order to fetch the radiation detection signals, the radiation detection signals are stored in a radiation detecting device for a fixed predetermined time without regard to an irradiation time of radiation and the radiation detection signals stored for the fixed predetermined time are read for every one image, thereby obtaining stored frame data for multiple images, and wherein the radiographic images are obtained based on the multiple stored frame data associated with irradiation.

6. The radiation detection signal processing method according to claim 5, wherein a storage time, which is the fixed predetermined time for storing the radiation detection signals, is equal to a reading time for one image for reading the radiation detection signals from the radiation detecting device.

7. The radiation detection signal processing method according to claim 6, wherein the multiple stored frame data associated with irradiation is from a stored frame when the irradiation is started to a frame immediately following a stored frame when the irradiation is ended.

8. The detection signal processing method according to claim 7, wherein the multiple stored frame data associated with irradiation is obtained based on added data, which is obtained by adding data from the stored frame when the irradiation is started to the frame immediately following the stored frame when the irradiation is ended.
